(19) United States
(12) Patent Application Publication
(10) Pub. No.: US 2016/0358213 A1
(43) Pub. Date: Dec. 8, 2016

(54) SHOP INFORMATION UTILIZATION SYSTEM

(71) Applicant: CUBLICMEDIA INC., Seoul (KR)

(72) Inventors: Jaesung CHOI, Seoul (KR); Hyunchul LEE, Gunpo-si, Gyeonggi-do (KR); Jaehan JEONG, Jinjusi, Gyeongsangnam-do (KR); Kwangjung KIM, Seoul (KR)

(21) Appl. No.: 15/241,078

(22) Filed: Aug. 19, 2016

Related U.S. Application Data
(63) Continuation of application No. PCT/KR2014/012878, filed on Dec. 26, 2014.

(51) Int. Cl. G06Q 30/02

(52) U.S. Cl. CPC G06Q 30/0259; G06Q 30/0201

(57) ABSTRACT

A store information use system for communicating with each of a plurality of stores through a store control device located in the corresponding store is provided. The system includes an information collecting unit configured to receive paging information about the pager in the corresponding store and operation information collected in a process of operating the store operation device from the store control device of the corresponding store, an information analyzing unit configured to draw store information associated with the corresponding store using the paging information or operation information, and an information using unit configured to generate a control signal for controlling an operation of the store operation device of the corresponding store based on the store information drawn for each store, the generated control signal being sent to the store control device of the corresponding store.

### CROSS-REFERENCE TO RELATED APPLICATIONS

The present application is a continuation of International Patent Application No. PCT/KR2014/012878, filed Dec. 26, 2014. The disclosure of the above-listed application is hereby incorporated by reference herein in their entirety.

### TECHNICAL FIELD

Embodiments of the inventive concepts described herein relate to a store information use system, and more particularly, relate to the store information use system for using big data provided from a store in the corresponding store using a pager which pages a waiting customer when it is his or her turn.

### BACKGROUND ART

There has been a growing trend to use a pager for notifying a customer who uses a store that it is his or her turn. Therefore, after the customer orders a product in the store, he or she may receive a pager from a clerk of the store, may determine whether it is his or her turn through the pager, and may receive the ordered product while returning the pager to the clerk.

Recently, as a pager having an advertisement function comes to the market, a waiting customer is prevented from becoming bored by outputting an advertisement configured with images and sounds through the pager for a waiting time until he or she receives a product he or she orders after he or she orders the product. Advertising earnings are made by using the waiting time.

However, the conventional pager is only used to faithfully perform an alarm function of notifying a customer that it is his or her turn and an advertisement function of outputting an advertisement for a waiting time. Store information which may be obtained using a pager is not used.

### DETAILED DESCRIPTION OF THE INVENTION

### Technical Problem

Embodiments of the inventive concepts provide a store information use system for analyzing store characteristics by performing statistics processing of paging information provided from a pager.

Embodiments of the inventive concepts provide a store information use system for recommending a store which may obtain a high advertisement effect by proceeding with an advertisement on a pager in consideration of store characteristics and an advertisement object.

Embodiments of the inventive concepts provide a store information use system for controlling an advertisement output through a pager in a store in consideration of environment information of the corresponding store and a variety of the other collectable information and controlling a store operation device operated in the corresponding store.

Other aspects, advantages, and salient features of the disclosure will become apparent to those skilled in the art from the following detailed description, which, taken in conjunction with the annexed drawings, discloses various embodiments of the inventive concept.

### Technical Solution

One aspect of embodiments of the inventive concept is directed to provide a store information use system for communicating with each of a plurality of stores through a store control device located in the corresponding store, the corresponding store comprising a pager for paging a waiting customer when it is his or her turn and a store operation device operated to operate the corresponding store. The system may include an information collecting unit configured to receive paging information about the pager in the corresponding store and operation information collected in a process of operating the store operation device from the store control device of the corresponding store, an information analyzing unit configured to draw store information associated with the corresponding store using the paging information or operation information, and an information using unit configured to generate a control signal for controlling an operation of at least part of the store operation device of the corresponding store based on the store information drawn for each store, the generated control signal being sent to the store control device of the corresponding store. The operation of the at least part of the store operation device of the corresponding store may be changed by the generated control signal.

### Advantageous Effects of the Invention

According to various embodiments, a store information use system may obtain information useful for managing a store from each of a plurality of pagers.

Also, according to various embodiments, a store information use system may effectively manage a store by analyzing information obtained from each of a plurality of pagers, environment information, and a variety of the other collectable information to use the analyzed result to manage the store.

Also, according to various embodiments, a store information use system may optimize an advertisement effect using each of a plurality of pagers by controlling a type and schedule of an advertisement using each of a plurality of pagers, based on the result of analyzing store information.

Also, according to various embodiments, a store control device may be used as a store automation platform by controlling a plurality of pagers and a store operation device located in a store under control of a store information use system as well as collecting information and providing the collected information to the store information use system.

### DESCRIPTION OF DRAWINGS

FIG. 1 is a block diagram illustrating an environment using a store information use system according to an embodiment;

FIG. 2 is a block diagram schematically illustrating a store information use system according to an embodiment; and

FIGS. 3 and 4 are block diagrams illustrating the flow of information based on the use of a store information use system of FIG. 2 according to an embodiment.

### BEST MODE

Hereinafter, the inventive concept is described in detail with reference to the accompanying drawings. The inventive concept and methods of accomplishing the same may be understood more readily by reference to the following detailed description of embodiments and the accompanying drawings. However, the inventive concept may be embodied in many different forms, and should not be constructed as being limited to the embodiments set forth herein. Rather, these embodiments are provided so that this disclosure will be thorough and complete and will fully convey the concept of the invention to those skilled in the art, and the inventive concept will only be defined by the appended claims. Like reference numerals designated like elements throughput the specification.

Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the inventive concept.

Terms used in the specification are used to describe specified embodiments of the inventive concept and are not intended to limit the scope of the inventive concept. The terms of a singular form may include plural forms unless otherwise specified. The terms used in the specification “comprise” and/or “comprising” do not exclude presence or addition of one or more other components other than the above-mentioned components.

Hereinafter, a description will be given in detail of a store information use system according to embodiments with reference to the accompanying drawings.

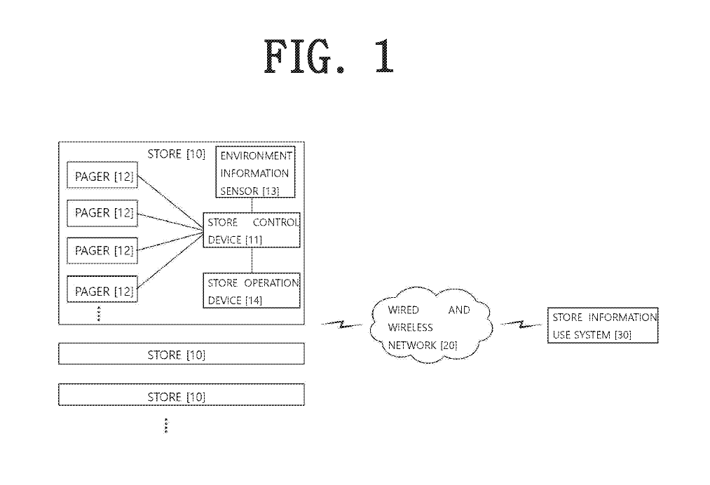

First of all, a description will be given in detail of an environment using a store information use system with reference to FIG. 1. FIG. 1 is a drawing illustrating an environment using the system using store information.

Referring to FIG. 1, a store information use system 30 may connect with each of a plurality of stores 10 over a wired and wireless network 20. The store information use system 30 may be, for example, a management server. The store information use system 30 may receive paging information about each of a plurality of pagers 12, environment information sensed by an environment information sensor 13, operation information collected in a process of operating a store operation device 14, and the like from each of the plurality stores 10, may analyze the paging information, the environment information, the operation information, and the like, and may use the analyzed result to manage each of the plurality of stores 10.

In detail, since the store control device 11 is located for each store 10, the store information use system 30 may communicate with the corresponding store 10 through the store control device 11 of the corresponding store 10.

The one store control device 11 and the plurality of pagers 12 may be located in the corresponding store 10. In addition, the environment information sensor and the store operation device 14 may be located in the corresponding store 10. Embodiments of the inventive concept are not limited thereto. For example, a plurality of environment information sensors and a plurality of store operation devices are located in each of the plurality of stores 10. If necessary, a plurality of store control devices may be located in each of the plurality of stores 10. Meanwhile, in various embodiments, each of the plurality of stores 10 may refer to a store which uses each of the pagers 12 which pages a waiting customer when it is his or her turn.

The store control device 11 may control a variety of devices located in each of the plurality of stores 10, including the plurality of pagers 12, the environment information sensor 13, and the store operation device 14, or may communicate with the variety of devices. For this purpose, the store control device 11 may connect with the devices located in each of the plurality of stores 10, including the plurality of pagers 12, the environment information sensor 13, and the store operation device 14, over a local network. The local network may not have wired and wireless limitation. For example, in the local network, communication such as radio frequency identification (RFID) communication or Bluetooth communication may be performed within a certain range. The local network may be without a limitation in a communication mode.

The store control device 11 may connect with the store information use system 30 using the wired and wireless network 20 to communicate with the store information use system 30. The wired and wireless network 20 may be, for example, a public network and may not have a limitation in type. Therefore, since the operation of the store control device 11 may be controlled by the external store information use system 30 over the wireless and wireless network 20, the store control device 11 may be under web control. In other words, the store control device 11 may control the various devices located in the corresponding store 10, under control of the store information use system 30.

Also, the store control device 11 may collect information from the devices included in the corresponding store 10, connected with the store control device 11 and may provide the collected information to the store information use system 30. For example, the store control device 11 may receive paging information from the plurality of pagers 30 in the corresponding store 10, may receive sensed environment information from the environment information sensor 13, may receive operation information collected in a process of operating the store operation device 14 from the store operation system 14, and may provide the received information to the store information use system 30 over the wired and wireless network 20.

Therefore, since collecting information from the plurality of devices in the corresponding store 10 and controlling the plurality of devices in the corresponding store 10, the store control device 11 may be used as a store automation platform.

In various embodiments, the store control device 11 may have a contact terminal for charging each of the plurality of pagers 12. If each of the plurality of pagers 12 is in contact with the contact terminal of the store control device 11 to be charged, information stored in the corresponding pager 12 may be sent to the store control device 11. Also, the store control device 11 may provide advertisement content, necessary information such as a schedule, or a control signal to the corresponding pager 12. In other words, in various embodiments, the store control device 11 is expanded from a role in charging or controlling each of the plurality of pagers 12 to a role as the store automation platform.

A main purpose of each of the plurality of pagers 12 may be to notify a waiting customer that it is his or her turn. For example, each of the plurality pagers 12 may page the waiting customer as it is his or her turn, in various manners such as indication on a display of the corresponding pager 12, vibration of the corresponding pager 12, and light ON/OFF of the corresponding pager 12. Each of the plurality of pagers 12 may be controlled by the store control device 11.

If there is paging from each of the plurality of pagers 12, paging information about the corresponding pager 12 may be stored in the corresponding pager 12. For example, a paging time when there is the paging from the corresponding pager 12 may be recorded as paging information in the corresponding pager 12. Embodiments of the inventive concept are not limited thereto. Therefore, if the paging information about the corresponding pager 12 is collected by the store control device 11 and is then provided to the store information use system 30, the store information use system 30 may analyze the paging information and may draw information associated with the number of paging indicating whether how many paging there are to the corresponding pager 12. Therefore, the store information use system 30 may draw information associated with the number of paging about each of the plurality of stores 10, indicating whether how many total paging there are in each of the plurality of stores 10.

Other than the function of notifying a waiting customer that it is he or her turn, each of the plurality of pagers 12 may include a display and a speaker and may output an advertisement for a waiting time of the waiting customer. In detail, the corresponding pager 12 may output an advertisement of content based on a schedule. An advertisement schedule and advertisement content of each of the plurality of pagers 12 may be controlled by the store control device 11 under control of the store information use system 30. For example, the store information use system 30 may send advertisement schedule information and advertisement content information to the store control device 11. The store control device 11 may control each of the plurality of pagers 12 based on the corresponding information. If an advertisement schedule or advertisement content is changed by the store information use system 30, an advertisement output on each of the plurality of pagers 12 may be changed.

If an advertisement is output from each of the plurality of pagers 12, advertisement exposure information about the corresponding pager 12 may be stored in the corresponding pager 12. For example, an advertisement playback time when an advertisement is output through the corresponding pager 12 may be recorded as the advertisement exposure information. Embodiments of the inventive concept are not limited thereto. Therefore, if the advertisement exposure information recorded in the corresponding pager 12 is collected by the store control device 11 and is then provided to the store information use system 30, the store information use system 30 may analyze the advertisement exposure information and may draw information associated with how many times an advertisement is reproduced on the corresponding pager 12. If necessary, the store information use system 30 may use the advertisement exposure information to analyze an advertisement effect.

In addition, each of the plurality of pagers 12 may include an input means and may receive personal information from a waiting customer for his or her waiting time. In the specification, the personal information may be, but not limited to, information about personal information of the waiting customer. It may be understood that the personal information includes response information of the waiting customer based on questionnaire items or feedback information by the waiting customer and is a generic term for information input by the waiting customer. For example, before an advertisement is output on each of the plurality of pagers 12, the corresponding pager 12 may receive personal information from a customer. However, embodiments of the inventive concept are not limited thereto.

Next, the environment information sensor 13 may sense environment information of each of the plurality of stores 10. The environment information may include, but not limited to, at least one of weather, temperature, humidity, or air cleanliness. For example, the environment information may be information indicating an environment inside and outside each of the plurality of stores 10.

The environment information sensed by the environment information sensor 13 may be an index of notifying customers of an overall environment of each of the plurality of stores 10 and may be used to control the plurality of pagers 12 and the store operation device 14. For example, the store information use system 30 may refer to environment information detected to determine an advertisement reproduced by each of the plurality of pagers 12 and may control the store operation device 14 using environment information detected to create a pleasant store environment for customers.

Meanwhile, the environment information sensor 13 may be included in, but not limited to, the store control device 11 or may be included in, but not limited to, each of the plurality of pagers 12 or the store operation device 14. For example, the environment information sensor 13 may be an independent device. The environment information sensed by the environment information sensor 13 may be collected by the store control device 11, and the collected information may be provided to the store information use system 30.

The store operation device 14 may mean a device operated by each of the plurality of stores 10 to operate the corresponding store 10. For example, the store operation device 14 may be, but not limited to, an air conditioning and heating machine, a sprinkler, a lighting device, or a wired and wireless router in the store control device 11. The store operation device 14 may be controlled by the store control device 11. For example, the store information use system 30 may send a control signal to the store control device 11 of each of the plurality of stores 10 to control an operation of the store operation device 14.

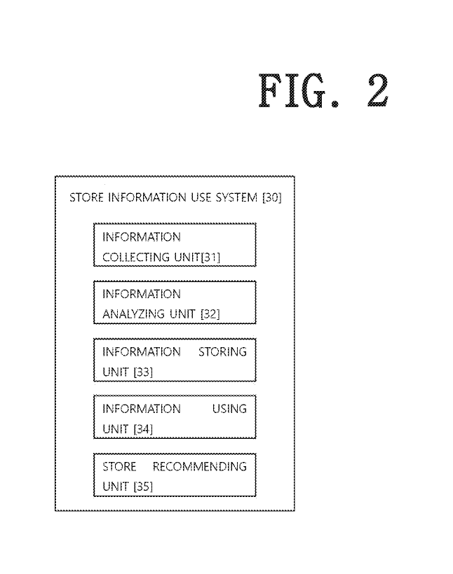

Meanwhile, operation information may be collected by the store operation device 14 in a process of operating the store operation device 14. The collected operation may be provided to the store information use system 30 through the store control device 11. The operation information may refer to all information which may be obtained through the store operation device 14. For example, if the wired and wireless router is included in the store control device 11 and if wireless-fidelity (Wi-Fi) communication is performed in each of the plurality of stores 10, the operation information may be, but not limited to, used records of Wi-Fi communication in the corresponding store 10. Hereinafter, a description will be given of the store information use system according to an embodiment with reference to FIG. 2. FIG. 2 is a block diagram schematically illustrating a configuration of the store information use system according to an embodiment.

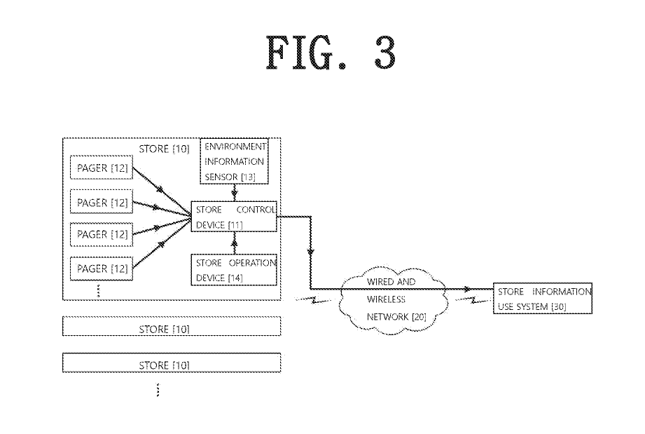

Referring to FIG. 2, a store information use system 30 may include an information collecting unit 31, an information analyzing unit 32, an information storing unit 33, an information using unit 34, and a store recommending unit 35. Herein, embodiments of the inventive concept are not limited to the components shown in FIG. 3. For example, the store information use system 30 may be implemented to include more or less components than the components shown in FIG. 3.

The store information use system 30 according to an embodiment may communicate with each of a plurality of stores 10 of FIG. 1 through a store control device 11 of FIG. 1 located in the corresponding store 10. The corresponding store 10 may include a plurality of pagers 12, each of which pages a waiting customer when it is his or her turn, an environment information collection sensor 13 of FIG. 1 which senses environment information of the corresponding store 10, and a store operation device 14 of FIG. 1 which operates to operate the corresponding store 10.

The information collecting unit 31 may receive a variety of information from the corresponding store 10. The information which may be received in the information collecting unit 31 may include, for example, but not limited to, at least one of paging information, environment information, operation information, or personal information.

The information collecting unit 31 may receive paging information for each of a plurality of pagers 12 of FIG. 1 in the corresponding store 10 from the store control device 11 of the corresponding store 10. In detail, paging information may be recorded in the corresponding pager 12, and the paging information recorded in the corresponding pager 12 may be sent to the store control device 11 using a local network to be collected in the store control device 11. Herein, if necessary, if the corresponding pager 12 may be in direct contact with a contact terminal of the store control device 11, the paging information recorded in the corresponding pager 12 may be sent to the store control device 11.

The store control device 11 may collect the paging information recorded in the plurality of pagers 12 in the corresponding store 10 and may send the collected paging information to the information collecting unit 31 over a wired and wireless network 20 of FIG. 1.

Also, the information collecting unit 31 may receive environment information sensed by the environment information sensor 13 from the store control device 11 of the corresponding store 10. In detail, the environment information sensed by the environment information sensor 13 may be sent to the store control device 11 to be collected by the store control device 11. The store control device 11 may send the collected environment information to the information collecting unit 31 over the wired and wireless network 20.

The information collecting unit 31 may receive operation information collected in a process of operating the store operation device 14 from the store control device 11 of the corresponding store 10. In detail, the operation information stored in the store operation device 14 may be sent to the store control device 11 to be collected by the store control device 11. The store control device 11 may send the collected operation information to the information collecting unit 31 over the wired and wireless network 20.

In addition, the information collecting unit 31 may receive personal information input to each of the plurality of pagers 12 from the store control device 11 of the corresponding store 10. The personal information input by the corresponding pager 12 may be collected by the store control device 11, and the collected information may be sent to the information collecting unit 31 over the wired and wireless network 20.

According to an embodiment, the information collecting unit 31 of the store information use system 30 may secure sufficient big data including the paging information, the environment information, the operation information, and the personal information, thus using the big data to manage the corresponding store 10.

The information analyzing unit 32 may draw store information associated with the corresponding store 10 using at least one of the paging information, the environment information, the operation information, or the personal information sent to the information collecting unit 31. Herein, the store information may be, but not limited to, information indicating a state or characteristic of the corresponding store 10. The store information may be drawn for each store 10.

To draw the store information associate with the corresponding store 10 using the paging information may be to perform statistics processing of the paging information sent to the information collecting unit 31, to produce the number of paging associated with the corresponding store 10, and to draw the store information associated with the corresponding store 10 based on the produced information associated with the number of paging. In the specification, the number of paging may refer to the number of paging associated with each of the plurality of pagers 12. The information analyzing unit 32 may produce information associated with the number of paging about whether how many paging is present for a period of time in the corresponding store 10, based on the paging information stored in the information collecting unit 31.

Using the produced information associated with the number of paging, the information analyzing unit 32 may obtain store information including at least one of a sale scale for the corresponding store 10, the number of customers which visit for the corresponding store 10, or a floating population for the corresponding store 10. However, the information which may be obtained through the information associated with the number of paging is not limited thereto. In detail, using the produced information associated with the number of paging, the information analyzing unit 32 may produce how many approximate customers visit approximately the corresponding store 10 for a period of time and how many people are present in a floating population of the corresponding store 10. In addition, the information analyzing unit 32 may produce an approximate sale scale of the corresponding store 10 in consideration of prices of products which are sold in the corresponding store 10.

Therefore, the information analyzing unit 32 may draw information which is useful to manage the corresponding store 10 through big data analysis using the produced information associated with the number of paging.

The information analyzing unit 32 may analyze store information including environment characteristics for the corresponding store 10, based on the environment information sensed by the environment information sensor 13. For example, the information analyzing unit 32 may obtain store information about how a temperature, humidity, illumination intensity, and the like of the corresponding store 10 are maintained. Therefore, the information analyzing unit 32 may obtain information sufficient for how the corresponding store 10 is managed.

In addition, the information analyzing unit 32 may draw a variety of store information associated with the corresponding store 10, based on operation information collected in a process of operating the store operation device 14. For example, the information analyzing unit 32 may obtain sale information of the corresponding store 10 in a process of operating a point of sales (POS) terminal as the store operation device 14. The information analyzing unit 32 may obtain music selection information of the corresponding store 10 through music output from a speaker as the store operation device 14. As such, using the operation information, the information analyzing unit 32 may draw a variety of store information which may not drawn from paging information and environment information.

Also, the information analyzing unit 32 may analyze store information including a client preference for the corresponding store 10 based on the personal information stored in the information collecting unit 31. For example, obtaining age information of a customer as personal information, the information analyzing unit 32 may draw age information of a main customer of the corresponding store 10. Obtaining order information of the customer as personal information, the information analyzing unit 32 may obtain information about tastes of the main customer of the corresponding store 10.

According to an embodiment, the information analyzing unit 32 of the store information use system 30 may analyze meaningful information about the corresponding store 10 from the store information including the paging information, the environment information, the operation information, and the personal information.

The information storing unit 33 may store basic information about the corresponding store 10, necessary for managing the corresponding store 10. For example, the information storing unit 33 may store store information including at least one of a brand name, a category of business, an address, or a customer age group for the corresponding store 10. However, the information stored in the information storing unit 33 is not limited thereto.

The information using information 34 may generate a control signal for controlling an operation of the store operation device 14 of the corresponding store 10 or an operation of each of the plurality of pagers 12 of the corresponding store 10 based on the store information drawn for each store 10. The generated control signal may be sent to the store control device 11 of the corresponding store 10, and an operation of the store operation device 14 of the corresponding store 10 may be changed by the generated control signal.

Therefore, according to an embodiment, the store information use system 30 may provide convenience to operate the corresponding store 10 or for a customer to use the corresponding store 10 by controlling an operation of the store operation device 14 based on the store information.

In detail, the information using unit 34 may control an advertisement output through the corresponding pager 12 of the corresponding store 10. In other words, the information using unit 34 may generate a control signal for controlling an operation of the corresponding pager 12 of the corresponding store 10 based on the store information drawn for each store 10 and may send the generated control signal to the store control device 11 of the corresponding store 10. An advertisement output from the corresponding pager 12 of the corresponding store 10 may be changed by the generated control signal.

For example, content and a schedule of the advertisement output through the corresponding pager 12 in the corresponding store 10 may be determined by the store information use system 30. Therefore, the determined schedule and content of the advertisement may be sent from the store information use system 30 to the store control device 11. The store control device 11 may control the corresponding pager 12 in the corresponding store 10 to output content based on the determined schedule of the advertisement, under control of the store information use system 30. However, the advertisement output from the corresponding pager 12 may be changed by the information using unit 34.

For example, the information using unit 34 may change the advertisement output through the corresponding pager 12 in the corresponding store 10 by reflecting environment information sensed by the environment information sensor 13 to the advertisement output through the corresponding pager 12. In detail, the information using unit 34 may send a control signal to the store control device 11 of the corresponding store 10 to change the advertisement output through the corresponding pager 12 in the corresponding store 10, based on store information drawn from the environment information.

For example, the information using unit 34 may control the corresponding pager 12 to output an advertisement for clothes such as padding jackets or an advertisement for heaters on a cold day, based on weather information sensed by the environment information sensor 13.

Therefore, according to an embodiment, the information using unit 34 of the store information use system 30 may optimize an effect of the advertisement output through the corresponding pager 12 by immediately coping with a change of store information and changing the advertisement output through the corresponding pager 12.

Also, the information using unit 34 may control an advertisement output from at least part of the store operation device other than the corresponding pager 12. For example, the information using unit 34 may control an advertisement output from a display of a POS terminal as the store operation device 14 or a display of a kiosk as the store operation device 14.

In detail, to change the operation of the store operation device 14 of the corresponding store 10 by the control signal generated by the information using unit 34 may be to change an advertisement output from each of the store operation devices 14 of at least some of the plurality of stores 10 by the generated control signal.

In addition, the information using unit 34 may control the store operation device 14 such that the corresponding store 10 may have an optimum environment. For example, the information using unit 34 may control a cooling device or a heating device in the corresponding store 10 when the corresponding store 10 is cold or hot, based on store information such as temperature detection information in the corresponding store 10.

Herein, in various embodiments, the information using unit 34 may control an operation of the store operation device 14 or the corresponding pager 12 using store information drawn from another store 10 other than the corresponding store 10. For example, the information using unit 34 may control an operation of the store operation device 14 or each of the plurality of pagers 12 of the other store 10 using store information (e.g., music selection information, illumination information, and the like) drawn from the store 10 with high sales.

According to an embodiment, the store information use system 30 may increase the efficiency of an operation of each of the plurality of stores 10 by controlling an operation of the store operation device 14 or each of the plurality of pagers 12 such that the corresponding store 10 is in an optimum state using store information. According to an embodiment, the information using unit 34 of the store information use system 30 may automatically manage each of the plurality of stores 10. Therefore, the store control device 11 may be used as a store automation platform.

The store recommending unit 35 may recommend the store 10 suitable for proceeding with an advertisement of each of the plurality of pagers 12 among the plurality of stores 10 to an applicant who applies for an advertisement of the corresponding pager 12 in consideration of an advertisement object of the applicant and store characteristics of each of the plurality of stores 10.

For example, the applicant who applies for an advertisement of the corresponding pager 12 may recommend the store 10 predicted to have an excellent advertisement effect when advertising the corresponding advertisement object on the corresponding pager 12, in consideration of what the advertisement object to be advertised is. For this purpose, store characteristics of each of the plurality of stores 10 may be considered. If necessary, a store preference of the applicant may be considered.

For example, when the applicant prefers the store 10 with a large sale scale or a number of visiting customers, store characteristics of the corresponding store 10 may be considered. Store characteristics of the corresponding store 10 may be considered to determine whether a target for the advertisement object of the applicant is associated with a main customer base of the corresponding store 10.

If necessary, the store recommending unit 35 may recommend the corresponding store 10 in consideration basic information of the corresponding store 10, stored in the information storing unit 33. For example, if there are a bland, a category of business, or a geographic location, and the like the applicant prefers, the basic information of the corresponding store 10, stored in the information storing unit 33, may be used.

According to an embodiment, the store recommending unit 35 of the store information use system 30 may optimize an advertisement effect when the applicant advertises the corresponding advertisement object on each of the plurality of pagers 12, by recommending an advertisement store through the store characteristics drawn through the paging information, the environment information, and the personal information.

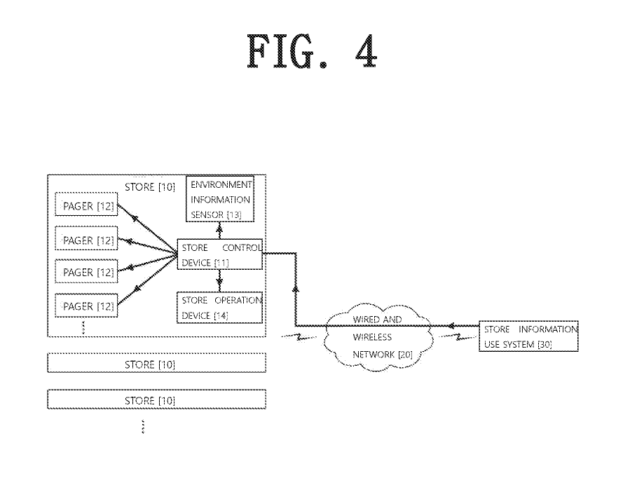

Hereinafter, a description will be given in detail of the flow of information based on the use of a store information use system with reference to FIGS. 3 and 4. FIGS. 3 and 4 are block diagrams illustrating the flow of information based on the use of a store information use system of FIG. 2.

Referring to FIG. 3, information collected from a plurality of pagers 12, an environment information sensor 13, and a store operation device 14 may be sent to a store control device 11 to be collected by the store control device 11. The collected information may be sent from the store control device 11 to a store information use system 30 through a wired and wireless network 20.

Referring to FIG. 4, information sent from the store information using system 30 to each of a plurality of stores 10 may be sent to each of the plurality of pagers 12, the environment information sensor 13, and the store operation device 14 through the store control device 11.

Therefore, the store information use system 30 may obtain store information from each of the plurality of stores 10 through the store control device 11 and may control the corresponding store 10 through the store control device 11 using the obtained store information.

Although the inventive concept has been explained by the embodiments shown in the drawings described above, it should be understood to the ordinary skilled person in the art that the inventive concept may be carried out in different detailed forms without changing the scope and spirit or essential features of the inventive concept. Therefore, it should be understood that the above embodiments are not limiting, but illustrative in all aspects.

1. A store information use system for communicating with each of a plurality of stores through a store control device located in the corresponding store, the corresponding store comprising a pager for paging a waiting customer when it is his or her turn and a store operation device operated to operate the corresponding store, the system comprising:
an information collecting unit configured to receive paging information about the pager in the corresponding store and operation information collected in a process of operating the store operation device from the store control device of the corresponding store;
an information analyzing unit configured to draw store information associated with the corresponding store using the paging information or operation information; and
an information using unit configured to generate a control signal for controlling an operation of the store operation device of the corresponding store based on the store information drawn for each store, the generated control signal being sent to the store control device of the corresponding store,
wherein the operation of the store operation device of the corresponding store is changed by the generated control signal.

2. The system of claim 1, wherein the drawing of the store information associated with the corresponding store using the paging information comprises:
producing information about the number of paging for the corresponding store by performing statistics processing of the paging information; and
drawing the store information associated with the corresponding store using the produced information about the number of paging.

3. The system of claim 1, wherein the pager outputs an advertisement for a waiting time of the waiting customer,
wherein the user using unit generates a control signal for controlling an operation of the pager of the corresponding store based on the store information drawn for each store and sends the generated control signal to the store control device of the corresponding store, and
wherein the advertisement output from the pager of the corresponding store is changed by the generated control signal.

4. The system of claim 1, wherein at least part of the store operation device outputs an advertisement, and
wherein the changing of the operation of the at least part of the store operation device of the corresponding store by the generated control signal comprises:
changing an advertisement output from each of store operation devices of at least some of the plurality stores by the generated control signal.

5. The system of claim 1, wherein the store control device of the corresponding store connects with the pager and the store operation device of the corresponding store over a local network, and
wherein the store control device of the corresponding store connects with the store information use system over a public network.

6. The system of claim 1, wherein the pager outputs an advertisement for a waiting time of a waiting customer,
further comprising:
a store recommending unit configured to recommend a store suitable for proceeding with an advertisement on the pager among the plurality of stores to an applicant who applies for the advertisement on the paper in consideration of an advertisement object of the applicant and the store information associated with the corresponding store, analyzed by the information analyzing unit.

7. The system of claim 1, wherein the pager receives personal information from the waiting customer for a waiting time of the waiting customer,
wherein the information collecting unit receives the personal information received in the pager in the corresponding store from the store control device of the corresponding store, and
wherein the information analyzing unit draws the store information associated with the corresponding store further using the received personal information.

8. The system of claim 1, wherein the corresponding store further comprises an environment information sensor configured to sense environment information of the corresponding store,
wherein the information collecting unit further receives the environment information sensed by the environment information sensor from the store control device of the corresponding store, and
wherein the information analyzing unit draws the store information associated with the corresponding store using at least one of the paging information, the environment information, or the operation information.
